(19) United States
(12) Patent Application Publication
(10) Pub. No.: US 2016/0302042 A1
(43) Pub. Date: Oct. 13, 2016

(54) Creating Analytics Associated with Personas and Devices

(71) Applicants: Brian Handly, Raleigh, NC (US); Jared Dean, Raleigh, NC (US); Matthew Davis, Raleigh, NC (US); Todd Moses, Raleigh, NC (US)

(72) Inventors: Brian Handly, Raleigh, NC (US); Jared Dean, Raleigh, NC (US); Matthew Davis, Raleigh, NC (US); Todd Moses, Raleigh, NC (US)

(21) Appl. No.: 15/091,614

(22) Filed: Apr. 6, 2016

Related U.S. Application Data
(60) Provisional application No. 62/144,983, filed on Apr. 9, 2015.

(51) Int. Cl. H04W 4/02; H04L 29/08; H04L 12/26; H04W 4/00

(52) U.S. Cl. CPC H04W 4/028; H04W 4/008; H04W 4/021; H04L 67/306; H04L 43/14

(57) ABSTRACT

The present invention is a method and system of locating mobile devices and building a database of the mobile device locations through the interaction of mobile devices with one or more proximity activation systems. The method and system uses beacon proximity activity to refine the location of a beacon and the relative position of one or more mobile devices to the beacon. As mobile devices come within a pre-determined proximity to a beacon, one or more personas may be associated with the mobile device based upon the beacon in proximity to the mobile device and the time of day associated with the activation of the proximity activation system, where each persona may be associated with any one of age range, profession, gender, shopping characteristic, store preference, and political affiliation.

This Non-Provisional application claims under 35 U.S.C. §120, the benefit of the Provisional Application 62/144,983, filed Apr. 09, 2015, Titled “Creating Analytics Associated with Personas and Devices”, which is hereby incorporated by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

A beacon is one implementation of an indoor proximity activation system that enables a smart phone or other Bluetooth enabled device to perform actions when in close proximity to a beacon receiver/transmitter.

Predicting the location of a mobile device may be enhanced through the incorporation of historical usage data based upon known usage patterns. Although not 100 percent accurate, metric and analytic information from interaction with one or more beacons may determine where a mobile device may be at a certain period of time. Predictions may facilitate interaction with merchants and others in proximity to the one or more mobile devices for which usage patterns are available.

When a mobile device is within range of a beacon, there is no information about the user of the device that is available for capture. Characterizing a user associated with a mobile device is ancillary to the function of a beacon, but highly relevant to use of beacons for location and identification of users associated with one or more mobile devices.

Characteristics of an individual user of one or more mobile devices are difficult to discern. The smartphone is a mobile device that is a unique technology device in that it is one of the first devices to be almost exclusively individual and personal. Additional mobile devices, such as tablets, iPads, internet capable watches, and other handheld mobile devices, provide similar functions and access to technology to users as they travel or move about on daily errands, much as the smartphone is capable of providing. Such mobile devices have become so useful that they are essential to users and are typically kept on or near the person of each user at all times, with users installing applications that are useful or simply desired so as to be readily available to the user whenever wanted. When a user of a mobile device interacts with one or more applications, vendors, or other users to provide information about the user, this information may be collected and analysis performed to determine some characteristics about a user. This information is highly dependent upon a mobile device user's willingness to provide such information, and whether the mobile device user provides accurate information in their responses. Characterizing a mobile device user can be very useful, but is difficult to accomplish.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a system diagram for an exemplary system configuration consistent with certain embodiments of the present invention.

FIG. 2 is a system diagram for loading one or more personas onto a mobile device consistent with certain embodiments of the present invention.

FIG. 3 is a process flow for the interaction of a mobile device with a persona based analytic system to build personas consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to multipoint trilateration refers to the mathematical process of determining absolute or relative locations of points by measurement of distances, using the geometry of circles, spheres, or triangles. In the multipoint trilateration, all points associated with a Bluetooth Low Energy (BLE) signal are considered simultaneously, permitting lower overall computational costs,

Reference throughout this document to a beacon refers to a low energy Bluetooth (BLE) device operating as an indoor proximity activation system that transmits packets of data that allow smart devices (such as phones, tablets, computers, handheld devices, game devices, etc.,) to be informed when they are in range, and where smart devices are capable of calculating their proximity to the beacon.

Mobile applications do not utilize cookies and for this reason the website advertising model, which relies heavily upon cookie tracking, does not work for mobile advertising. In common practice, cookies track the locations a user visits across the web through the mechanism of placing a small tracking file, or cookie, within a user's computer system. These cookies are usable by the application or web page that placed it within the cookie folder on the user computer file system. In a non-limiting example, because cookies can't track digital locations in mobile devices, we can use physical location like latitude and longitude coordinates or activation by a proximity activation system as a real world tracking pixel to “cookie” where someone visits in the real world.

Utilizing location information gathered from a proximity activation system, such as a beacon, provides highly accurate location information for a mobile device that comes within range of the beacon's signal. In a non-limiting example, when a mobile device detects a Beacon's signal, an application on the mobile device uses the Received Signal Strength Indication (RSSI), which is compared against a pre-set distance to signal strength ratio, to determine proximity to the Beacon as well as the accuracy of its estimation of proximity. The stronger the signal, the more confident the mobile device can be about the proximity of the Beacon. Refining the location of a mobile device may require a location determination system to increase location accuracy.

One of the greatest challenges in mobile advertising is getting an accurate sense for where people visit in the physical world, in combination with the time of such visits. The confluence of time and location of a visit to a known location by a consumer is a valuable set of information that may be captured through the use of beacon “bumps”. The event of a user passing within range of a beacon, so as to activate the beacon and create a “bump”, establishes a fixed point of reference for identifying with certainty that a mobile device was in a particular physical location at a specific time. Because most mobile devices are the property of a single individual, these beacon “bumps” assist in identifying and categorizing the habits and preferences of individuals while remaining an anonymous source of information.

In an exemplary embodiment, data is collected by the Reveal™ SDK or API installed on each mobile device associated with an activation point for the proximity activation system. The Reveal™ application server may collect data about the smart device and may include the access level for the application, such as client, and a Uniform Resource Locator (URL).

Additionally, in an exemplary embodiment, event data may be collected that may consist of specific information captured about each beacon bump, when the proximity activation system is composed of one or more beacons. This data is returned to the mobile location database by the Reveal™ SDK or API on a Reveal™ application server and may include the access level for the application, such as client, and a Uniform Resource Locator (URL).

Utilizing the point rank calculation, the physical location of the indoor proximity activation system, as represented by a Beacon, may be determined with an accuracy of approximately 10 meters or less. Upon determining the physical location the application server contacts a location database to determine the type of location in which the detected Beacon is installed. The application server may then contact a geographic or physical place application to determine the type of location associated with the physical location of the Beacon. In a non-limiting example, the application server may contact Google Places Application Programming Interface (API) as one example of a geographic location application. The location type information is then stored in the database table of geographic information. If there is no place type in the Google Places API for the location identified, additional location information may be sought at other location sites that are publicly available to attempt to determine the place type. In a non-limiting example, the application server may receive information back from the Google Places API that the beacon identified at the discovered location is installed in a café.

With this identification, the application server may then build one or more classifications for the beacon at that specific location. In the non-limiting example where the beacon is identified as being installed in a café, the application server may map a café to a classification of Food&Drink >café, which then has the capability to personify any smart device that comes into contact with that classified beacon as a coffee drinker. It should be noted that a beacon may have more than one classification identified with that beacon based upon inferences for the types of retail or other activity that is associated with the place type.

In an exemplary embodiment, personas may be classified to a beacon based upon the physical location of the beacon with regard to retail or other establishments that are within a pre-specified proximity to the beacon. The beacon, when bumped, may indicate that the mobile device that collected the bump should be associated with the behaviors of defined personas, such as shopping at one or more retail establishments that are within the location proximity of a beacon. A separate persona may be added, updated, or removed based upon the classification of the beacon and the establishments, shops, or venues associated with the beacon or within which the beacon is installed. A mobile device may have multiple personas associated with the device for each beacon encountered based upon the beacons with which the beacon has come into proximity contact.

In an embodiment, demographic information may be combined with collected data from smart mobile devices. This information may include gender, income range, education level, age range, and additional demographic information available from public sources. The public sources consulted may include, but are not limited to, US Bureau of the Census, automotive data, TV viewing data, purchase data, and grocery store shopping data. The demographic data may provide the creation of new personas or may strengthen existing personas, enhancing the targeting and placement of advertising and informational messages and communications.

A mobile device having the Reveal™ SDK downloaded will track and manage gathered information about the user or owner of the mobile device. To facilitate analytic determinations regarding the use and location of the mobile device, information tables are established for each mobile device.

In an exemplary embodiment, the discovery of a gender bias, and thus the creation of gender based personas, for any particular mobile device presents an opportunity for advertisers to more accurately identify and present targeted ads based upon gender and transmitted to gender-based personas, and associated with location. A challenge in mobile advertising is getting an accurate sense for where people visit in the physical world and a sense of the gender of a user of a mobile device once location of the mobile device in the physical world has been determined. The confluence of time and location of a visit to a known location by a consumer is a valuable set of information that may be captured through the use of beacon “bumps”. The event of a user passing within range of a beacon, so as to activate the beacon and create a “bump”, establishes a fixed point of reference for identifying with certainty that a mobile device was in a particular physical location at a specific time. However, beacon “bumps” do not reveal any specific information about the user of a mobile device that may be used to ascertain gender of that user.

In an exemplary embodiment, personas may be classified to a mobile device based upon the gender classification that has been established for the mobile device. A beacon, when bumped, may indicate the type of shopping, merchant, or other establishment associated with the beacon as being more biased toward one gender or the other. Personas may be assigned to a mobile device based upon the gender bias presumed for one or more beacons that are co-located with shops or other establishments having a gender bias. By way of example and not of limitation, if a beacon is installed within a store that sells women's clothing exclusively, such a shopping location might prefer to target female shoppers only, or may wish to provide incentives or rewards primarily to female shoppers. In this example, it would not be terribly useful to insert a persona associated with that clothing store into a mobile device that has been classified with a gender bias of male. Alternatively, traditionally male shopping venues such as sporting goods or outdoor merchandizers would benefit from placing a persona onto a mobile device having a male gender bias.

Additionally, the Reveal™ application server may provide an estimation of how long a particular persona, of whatever type, may be relevant for commercial or monetization purposes once associated with a particular mobile device. Personas may be established with a pre-set decay period, where the decay period is set based upon business rules maintained and managed by the system. In a non-limiting example, a persona may be established for a beacon that is located within a coffee shop. The decay period may be set to provide a benefit to customers in recognition of certain behaviors, such as a coupon for frequent customers to the coffee shop. In this example, the decay period may be set to be very short as coffee is a frequent purchase and the coffee shop may want to encourage that frequency to increase the wallet spend of frequent shoppers.

In an alternative embodiment, a pre-set decay period for a persona interaction with a beacon installed in a car dealership may be months in length, due to the fact that a vehicle purchase is not generally an impulse and it may be weeks or months before the mobile device returns to the proximity of that beacon. The Reveal system tracks and manages all personas associated with every mobile device that has an installed Reveal application, and manages and tracks all decay times for each persona. This management and tracking by the system provides advertisers and other clients of the system with the most accurate targeting of one or more mobile devices for ads, event information, trigger phrases, or any other commercial or informational message a client of the system wants to communicate to a targeted mobile device user.

In an additional embodiment, the Reveal system may periodically rebuild all personas being tracked and managed by the system. This persona refresh cycle permits the system to remain flexible and dynamic by purging personas that have been active for long periods of time with no further interaction with the originating beacon and updating all personas to the latest version. This purge and refresh of all personas may be performed on an automatic basis, either in accordance with a pre-set time interval or upon demand by a system manager. If performed in accordance with a pre-set time interval that purge and refresh may remove all personas and rebuild the entire scope of personas programmatically without human intervention. This pre-set time interval may be set to any time schedule, period, or upon trigger events recognized by the system.

In an alternative embodiment, a pre-set decay period for a persona interaction with a beacon installed in a car dealership may be preferentially associated with mobile devices for which a male gender bias has been established. Such an association may be months in length, due to the fact that a vehicle purchase is not generally an impulse and it may be weeks or months before the mobile device returns to the proximity of that beacon. The Reveal system tracks and manages all personas and the gender bias associated with each mobile device that has an installed Reveal application, and manages and tracks all decay times for each persona of any gender bias, male, female, or neutral. This management and tracking by the system provides advertisers and other clients of the system with the most accurate targeting of one or more mobile devices for ads, event information, trigger phrases, or any other commercial or informational message a client of the system wants to communicate to a targeted mobile device user, particularly associated with a calculated and assigned gender.

In an exemplary embodiment, the Reveal™ application server may utilize the location information derived from the point rank analysis in combination with a logged recorded history for the mobile device to create one or more predictive recommendations for subscribers and users of the Reveal™ system. In this exemplary embodiment, the application server may have an installed module that analyzes the beacon activations geographical location in relation to the time of day to determine activities associated with a physical path over time. Multiple personas are associated with each mobile device that activates particular beacons, including gender-based, location-based, and other personas such as those affiliated with shopping preferences. An analysis of the path taken by a mobile device may be associated with one or more personas that have been established for that particular mobile device. In this fashion, the analysis result may present an ability to predict, for a given time of day and path taken, where the mobile device is likely to be located next. In looking forward, the application server may set a check point to determine if the next beacon activation for the particular mobile device is associated with the beacon that would be encountered next for the time of day and predicted pathway. With this feedback and verification signal, the application server may communicate a particular message, ad, or other signal to the relevant persona or personas associated with the mobile device.

In an embodiment, mobile device users who perform a particular activity on a routine or highly frequent basis are those individuals for whom marketing is unnecessary. However, incentives may be presented to such mobile device users in an attempt to increase wallet spend. Incentives may also be presented when an analysis of behaviors of such frequently encountered mobile device users provides an indication that the mobile device user activity, as measured by beacon interactions, is decaying over time. Such incentives may be presented not to increase wallet spend, but to attract and retain such customers to retail establishments in proximity to the beacons with which the user interacts. This increases the customer lifetime value and important metric in marketing activities.

In this non-limiting example, the application server may be able to provide, for a small fee or other consideration, predictive information on the likely purchases at any particular shopping location or performance venue to permit the generation of “instant savings” coupons, special deal ads, or informational messages tailored for one or more personas on that mobile device. The shopping location contacted may instead choose to opt out of transmitting any information to the one or more personas located on the mobile device unless a trigger event has occurred. Trigger events are those events that are established by a shopping location to set the conditions that must exist to permit the application server to issue coupons, ads, informational messages, or other signals to one or more personas located on the mobile device.

In an exemplary embodiment, characterizing one or more personas associated with a mobile device may be performed based upon the path of beacon activations over a span of time. This characterization may be an indicator of what type or specific application may be downloaded to the mobile device. In a non-limiting example, if a persona is characterized based upon the mobile device activating beacons associated with games, comic books, costume shops, and other establishments catering to a persona that is interested in gaming, the application server may predict that the latest game application or update may be offered to that mobile device. The application server could then send application information to the mobile device. In an alternative embodiment, if a persona is characterized based upon the mobile device activating beacons at a sports venue, followed by a visit to a pub or sports bar, which may indicate a mobile device user who is interested in sports or other competitive activities, the application server may predict other sports or competitive performances in which the mobile device might have an interest and present ads for tickets to such additional performances, with or without discounts that might be available as added incentives to purchase tickets to the next performance.

In an embodiment, the Reveal™ application server may integrate with a plurality of advertising servers. This direct communication pathway will permit tracking and management of every advertising and informational message delivered to every device within the sphere of the advertising server. The direct integration with advertising servers may strengthen attribution reporting and permit stronger correlations between delivered messages and mobile devices. This data may be collected in one or more Reveal™ and/or advertising server databases and managed by one or more Reveal™ analytics management processes.

In an embodiment, the Reveal™ application server may evaluate latitude and longitude data provided by a GPS process associated with each mobile device on which a Reveal™ enabled application is installed. This data is provided upon the startup of the application. The data may be analyzed and utilized to build known locations, such as home, work, and other locations for the mobile device, and additional persona information based upon location history. This information will be stored upon and managed by one or more Reveal™ application servers.

In an additional embodiment, a Reveal™ application server may utilize metrics and other collected data to evaluate all known locations, personas, and historical behaviors to create analytics for all mobile devices known to the system. This analytic information may be used to create predictive advertising for the mobile devices. In this process, advertising data may be targeted for delivery to a mobile device based upon predictions of future intent for each mobile device and personas associated with mobile devices.

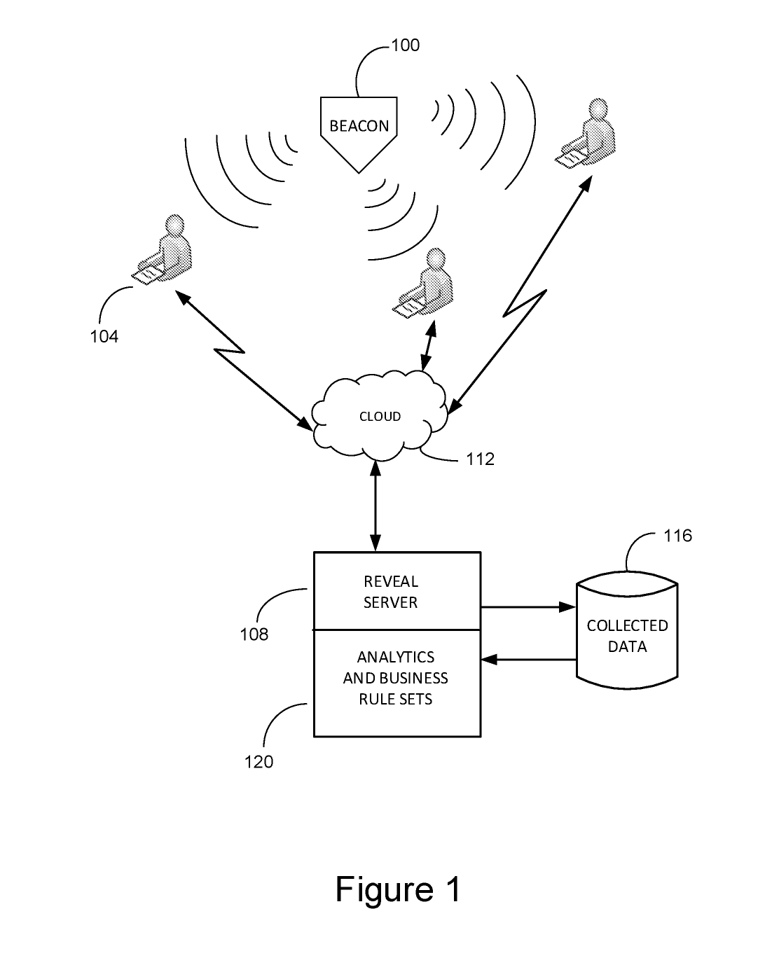

Turning now to FIG. 1, this figure presents a system diagram for an exemplary system operation consistent with certain embodiments of the present invention. An indoor proximity activation system 100, such as a beacon, may be installed within physical locations such as stores, sporting areas, malls, parks, cafes and restaurants, or any other physical location where information may be transmitted to a mobile device 104. A beacon bump is an activation indication from the indoor proximity activation system 100 that is transmitted to the Reveal™ application server 108 when a mobile device upon which the Reveal™ SDK has been installed. When a beacon bump is detected, the beacon information, containing at least the uuid, major, minor, and name fields, is transmitted to the Reveal™ application server 108 through one or more cloud 112 servers. The application server 108 stores the transmitted beacon information in a relational database 116 containing all of the collected data from all mobile devices, either as a new entry into a beacon data table or as an update to an entry already stored in the beacon data table. The application server 108 also adds geographical data, the latitude and longitude, for the beacon into a data table. Additionally data regarding the mobile device manufacturer, operating system type and other metrics are stored in a separate data table on the application server 108.

After the application server 108 has completed a refinement calculation for the geographical location of the indoor proximity activation system 100, the application server 108 may seek to identify the location in which the indoor proximity activation system 100 has been installed. In a non-limiting example, the application server 108 may contact a places identification service 116, such as Google Places, through the API and present the physical location information to check the type of place in which the indoor proximity activation system 100 is operating. Once the type of place is returned from the places identification API, this information is stored in the relational database 116 and associated with that particular beacon.

The Reveal™ Server 108 may also contain one or more sets of analysis and business rule sets 120 to determine what persona should be identified with each mobile device that reports a bump with a particular beacon 100. The personas are associated with each mobile device 104 based upon the location of the beacon 100 and the date and time of day the bump occurred. Additionally, business rule sets are established to decay personas on a periodic interval. The personas are removed from each mobile device 104 and then rebuilt and reinstalled so as to dynamically refresh the personas associated with each mobile device 104. This persona decay and rebuild process may happen programmatically or manually, with different decay intervals established by one or more business rule sets.

Upon the conclusion of this operation, the Reveal™ system has a table of beacon information and associated data regarding the number of mobile device activations near the indoor proximity activation system 100, the type of place in which the indoor proximity activation system 100 is installed, and the precise physical location of the indoor proximity activation system 100 within that location.

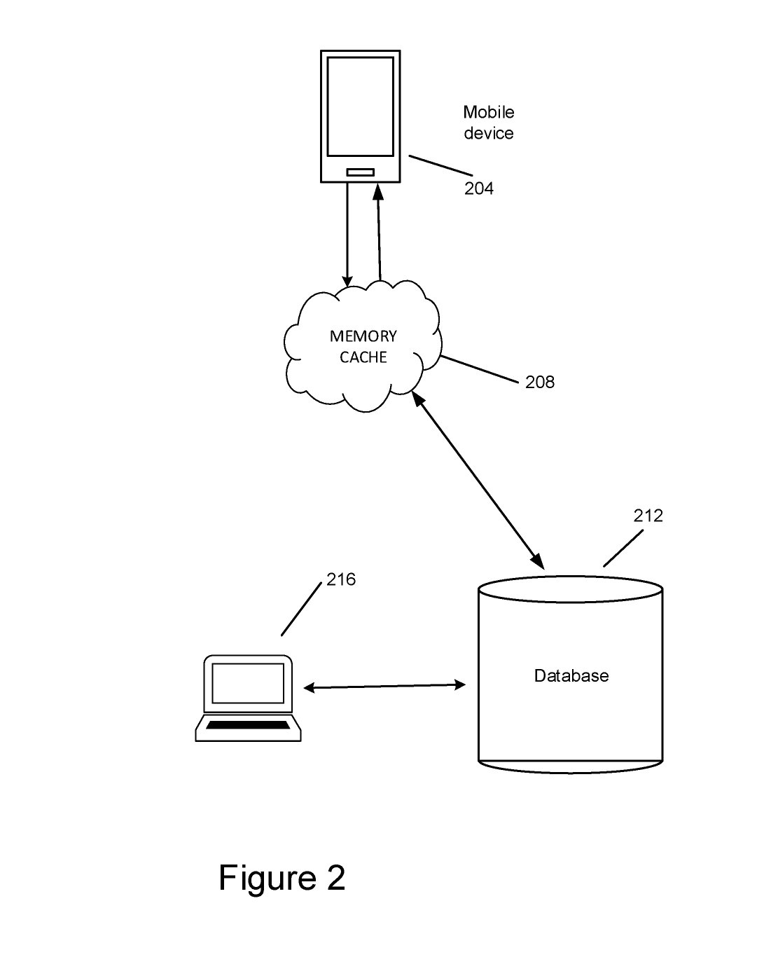

Turning to FIG. 2, this figure presents a system diagram for loading one or more personas onto a mobile device consistent with certain embodiments of the present invention. One or more mobile devices 204 connect to a memory cache 208 maintained on the Reveal™ server. The memory cache 208 is an active component within the server to communicate with the mobile devices 204 and establish one or more personas that are to be associated with the mobile device 208. Each mobile device 204 may have multiple personas attached to the mobile device 204 based upon business or analytic rule sets. The business or analytic rule sets are stored within a digital database 212 associated with the Reveal™ server. An analytic module 216 retrieves the location of the beacon that was activated by the mobile device 204, time of day of interaction with a mobile device 204, and the business or analytic rule set and creates one or more personas that meet the criteria established by the rule set for the beacon and time of day of the beacon interaction with the mobile device 204. The persona and the associated mobile device 204 are stored within the database 212 for management and tracking of the persona against the mobile device 204.

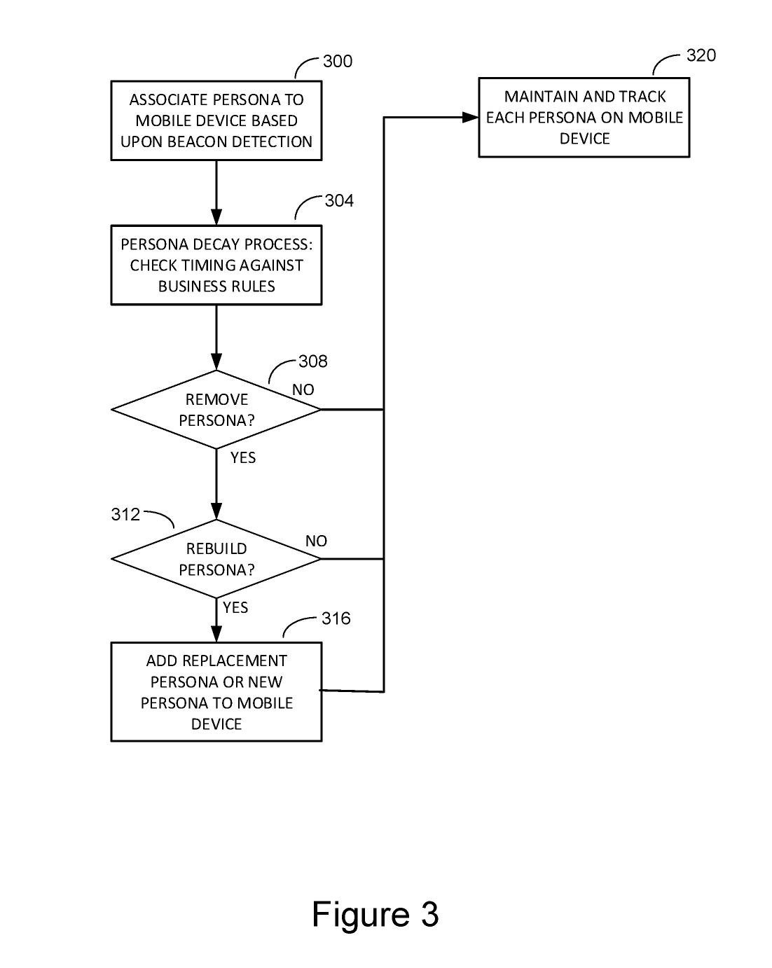

Turning to FIG. 3, this figure presents a process flow for the interaction of a mobile device with a persona based analytic system consistent with certain embodiments of the present invention. When the system is initialized, the Reveal™ server associates all relevant personas with each mobile device that has a Reveal™ capable application installed on the mobile device at 300. Initially there might be no personas associated with a mobile device until sufficient time has passed for the device to be tracked and beacon bumps recorded. After the association of the persona with the mobile device at 304, one or more rules from the analytic and/or business rule sets are invoked to begin to track the amount of time since the triggering event. Personas may be assigned at any time to a mobile device, and one or more personas may be assigned to a mobile device at any given time. In a non-limiting example, one or more personas may be assigned when the mobile device first encounters a beacon, or personas may be assigned to the mobile device after some time and tracking has established a pattern for which a persona may be initiated, or personas may be added, updated, or removed on a pre-set time schedule according to one or more business rules, or one or more particular persona decay rates associated with each persona.

The amount of time that a particular persona is to be active within a mobile device before being removed, updated or modified is the decay of the persona. The decay rate is based upon the amount of time that a persona has been calculated to remain relevant for any particular mobile device and beacon. The relevancy period is established and managed by the business rules maintained in the Reveal™ server, and each persona has an associated relevancy period and decay rate. The decay for each persona may be different and is dependent upon business requirements established for the persona.

At 308, the decay parameter for each persona is checked to determine if the persona is to be removed under the relevant business rule. If the persona decay parameter indicates the term of existence for the persona is complete, the persona may be removed. Additionally, the persona may be removed for any number of business reasons pre-set in one or more business rules. If the persona is removed, the system may next interrogate the business rules to determine if the persona is to be rebuilt at 312. If the persona is to be rebuilt, the system at 316 is active to either build an entirely new persona and transmit the new persona to the mobile device, or update the persona that was removed to add new or updated functionality and reinstall the persona. A persona may be removed, replaced, updated, and/or added on a timed basis automatically during a given time period, may be added automatically on an ad hoc basis, or may be added manually by a system manager or user. As a non-limiting example assume a mobile device bumps into a beacon in a cosmetics store located within a shopping mall. At the next time interval where personas are being assigned to devices the mobile device may receive several personas based on this single beacon bump. The mobile device registered a visit to a cosmetics store so the mobile device would receive a shopping—fashion & beauty persona, additionally the mobile device would receive a shopping-mall shopper persona, the likelihood of the mobile device belonging to a female owner, based upon the tracking module understanding that these types of beacon bumps are more commonly associated with a female mobile device user, would increase and perhaps add a gender—female persona to be sent to the mobile device. These three personas will all have a different decay rates established and managed by a Reveal™ server management module. The shopping mall persona might only have a relevancy of 30 days, while the cosmetics persona (because of the longer shelf life and durable nature of cosmetics) will have a 90 day period of relevancy. The gender persona assignment, since it is a permanent state, will be used for 12 months, with the option to be reset at any time based upon additional collected beacon data.

At 320, each persona is managed, updated, and tracked by the system to insure that the persona on each mobile device actively reports the data required by the Reveal™ system.

The Reveal™ server returns the requested attributes for the mobile device to the SDK associated with the mobile device. The mobile device attributes, such as the mobile device classification and assigned personas, may be used to deliver ads or information to device personas based upon a hierarchical listing of personas. In a non-limiting example, a high value persona is one for which there may be active advertisers willing to pay a premium to present their ads or information to a location that has the persona type for which their goods are appropriate.

While certain illustrative embodiments have been described, it is evident that many alternatives, modifications, permutations and variations will become apparent to those skilled in the art in light of the foregoing description.

What is claimed is:

1. A method of communication delivery to mobile devices, comprising:
capturing a plurality of mobile device activations by a proximity activation system;
determining location of the proximity activation system activated by a pre-determined number of mobile device activations;
associating the proximity activation system location with a physical address or location;
determining one or more persona types having characteristics of a user of a mobile device through an analysis of collected proximity activation system interactions;
associating the one or more personas with each mobile device; and
delivering communications targeted to one or more personas associated with each mobile device.

2. The method of claim 1, further comprising refining the proximity activation system location by determining the mobile device activation having the highest rank and associating the proximity activation system with the geographic location of said mobile device activation.

3. The method of claim 1, further comprising the creation of one or more personas to be installed on the mobile device, where each persona may be associated with any one of age range, profession, gender, shopping characteristic, store preference, political affiliation, home location, and work location.

4. The method of claim 3, where a mobile device has a plurality of installed personas.

5. The method of claim 1, where a persona may be updated based upon the analysis of collected metrics for a particular mobile device.

6. The method of claim 1, where the location of a physical address includes the location of a physical address for each proximity activation system a mobile device activates within a pre-determined period of time.

7. The method of claim 6, where the location of physical addresses are analyzed to track the mobile device and create a tracking path for the mobile device.

8. The method of claim 7, further comprising analyzing the tracking path to predict a next proximity activation system that will be in range of the mobile device.

9. The method of claim 8, further comprising transmitting the physical location of the predicted next proximity activation system to the mobile device.

10. A system of communication delivery to mobile devices, comprising:
a server having a processor in wireless communication with a plurality of mobile devices;
a software module operative to capture a plurality of mobile device activations by a proximity activation system;
the server determining location of the proximity activation system activated by a pre-determined number of mobile device activations;
a software module for associating the proximity activation system location with a physical address or location;
a software module associating one or more personas through an analysis of collected metrics with each mobile device that activated the proximity activation system; and
delivering communications from the server to the plurality of mobile devices targeted to one or more personas associated with each mobile device.

11. The system of claim 10, further comprising refining the proximity activation system location by determining the mobile device activation having the highest rank and associating the proximity activation system with the geographic location of said mobile device activation.

12. The system of claim 10, further comprising the creation of one or more personas to be installed on the mobile device.

13. The system of claim 12, where each persona may be associated with any one of age range, profession, gender, shopping characteristic, store preference, political affiliation, home location, and work location.

14. The system of claim 12, where a mobile device has a plurality of installed personas.

15. The system of claim 10, where a persona may be updated based upon the analysis of collected metrics for a particular mobile device.

16. The system of claim 11, where the location of a physical address includes the location of a physical address for each proximity activation system a mobile device activates within a pre-determined period of time.

17. The system of claim 16, where the location of physical addresses are analyzed to track the mobile device and create a tracking path for the mobile device.

18. The system of claim 17, further comprising analyzing the tracking path to predict a next proximity activation system that will be in range of the mobile device.

19. The system of claim 18, further comprising transmitting the physical location of the predicted next proximity activation system to the mobile device.
